(19) United States
(12) Patent Application Publication
(10) Pub. No.: US 2011/0080397 A1
(43) Pub. Date: Apr. 7, 2011

(54) BACKLIGHT DRIVE APPARATUS AND VIDEO DISPLAY APPARATUS

(75) Inventors: Yasunori Yamamoto, Osaka (JP); Shinichiro Kataoka, Osaka (JP); Tsukasa Kawahara, Kyoto (JP); Go Takata, Hyogo (JP); Ryuji Ueda, Osaka (JP); Daisuke Itou, Osaka (JP)

(73) Assignee: Panasonic Corporation, Osaka (JP)

(21) Appl. No.: 12/821,413

(22) Filed: Jun. 23, 2010

(30) Foreign Application Priority Data
Oct. 7, 2009 (JP) 2009-233017

(51) Int. Cl. G09G 5/00; H05B 37/02; G09G 3/36

(52) U.S. Cl. 345/214; 315/185 R; 345/102

(57) ABSTRACT

A backlight drive apparatus for current driving a plurality of strings has a period in which at least one of the strings is a current driven idly during a liquid crystal OFF period, in addition to a current driving period in which video information is displayed via liquid crystals. A failure detection section can monitor stabilized detection voltages in the period when current driven idly and detects failure state of the backlight panel.

### BACKGROUND OF THE INVENTION

1. Technical Field

The present invention relates to a backlight drive apparatus and a video display apparatus, more particularly, to a liquid crystal display apparatus capable of accurately detecting failure in the backlight thereof during viewing.

2. Background Art

As shown in FIG. 8, for example, Japanese Patent Application Laid-open Publication No. 2003-332624 discloses a liquid crystal display apparatus in which LEDs (light-emitting diodes) are used for the backlight thereof. Plural LEDs are connected to one another in series, thereby forming one string 101. The liquid crystal display apparatus is equipped with the plural strings, a variable power source 100 and current sources 115, 116 and 117. The respective strings are used to irradiate various areas inside the screen thereof. The variable power source 100 generates a power output voltage V100 and supplies the voltage to the plural strings. The current sources 115, 116 and 117 intermittently turn on/off the plural strings by passing currents having desired values through the strings, thereby performing light modulation. The variable power source 100 adjusts one kind of power output voltage V100 via a negative feedback path 102 so that the minimum string node voltage among string node voltages V112, V113 and V114 (hereafter referred to as string node voltages) becomes a predetermined reference voltage. The reference voltage is set so as to be minimal in a range in which the current sources can drive the respective strings. Hence, the current sources can drive the respective strings by using a desired pulse current waveform while power loss is reduced. As a result, low power consumption can be attained.

On the other hand, the backlight may become faulty due to the disconnection, grounding or short-circuit of the strings. Failure caused by disconnection and grounding lowers the string node voltages from the predetermined value, and failure caused by short-circuit and degradation raises the string node voltages from the predetermined value. Hence, failure is detected and the driving of the backlight can be stopped by setting a predetermined threshold value and by comparing the threshold value with the raised/lowered values, as disclosed, for example, in Japanese Patent Application Laid-open Publication No. 2009-104848 shown in FIG. 9.

In this case, the string node voltages become approximately equal to the reference voltage in the steady state during the ON period other than transient states, such as the rising and lowering states. For this reason, failure in the strings can be detected accurately using the threshold value.

### SUMMARY OF THE INVENTION

However, in the technologies disclosed in the above-mentioned patent documents, there are cases in which failure in the strings cannot be detected accurately while a video signal is viewed.

In a liquid crystal display apparatus, an attempt to partly adjust the light amount of the backlight inside the screen is made in conjunction with the brightness information of a video signal. This attempt is intended to attain low power consumption and high picture quality, such as high brightness and high contrast. In this case, the timing values required for ON/OFF driving the respective strings are generally different among the strings. Hence, the number of the strings that turn ON simultaneously changes with time according to the brightness information of the video signal. Furthermore, an on-duty ratio representing the ratio of the ON period to one ON/OFF cycle changes with time according to the brightness information of the video signal. Since the number of the strings being in the ON state and the on-duty ratio change significantly, a total current J100 representing the total of the currents flowing through the respective strings changes significantly. As a result, the control operation of the variable power source 100 via the negative feedback path 102 changes significantly and transiently.

Moreover, since the ON/OFF drive timing values are different among the strings as described above, there is a case in which when one string is in a steady state during the ON period, another string becomes a transient state. In this case, when the one kind of power output voltage V100 from the one variable power source 100 drives both the strings, the string node voltage of the one string being in the steady state changes significantly due to over/undershoot of the power output voltage V100 in the other string. When the string node voltage changes significantly as described above, the string node voltage exceeds the threshold value transiently. As a result, the failure detection configurations according to the above-mentioned conventional examples may malfunction in some cases.

To solve the problems encountered in the conventional examples, one aspect of the present invention is intended to suppress the change in the string node voltages (detection voltages) so that failure can be detected securely.

For the purpose of solving the above-mentioned problems, one aspect of the present invention provides a suitable test signal for detecting LED abnormality, in addition to LED driving based on the video signal to be seen by the viewer. Furthermore, in addition to a video signal output period, an LED test signal output period is provided in a frame including a period in which LED abnormality is detected. Moreover, during LED driving, the liquid crystals are switched off using the test signal, that is, the transmittance of the liquid crystals is made lowest.

With a backlight drive apparatus and a video display apparatus according to one aspect of the present invention, the total pulse signal generation section thereof generates a total pulse signal including one transmission pulse signal and one shield pulse signal at each PWM cycle Tpwm. Furthermore, the sink current generation section thereof can adjust a sink current to a transmission pulse current corresponding to the transmission pulse signal and to a shield pulse current corresponding to the shield pulse signal. Hence, the backlight drive apparatus balances the sink currents respectively flowing through N strings with respect to time to lower the dependency on a video signal, thereby being capable of reducing the change in the total sink current. As a result, the backlight drive apparatus can suppress the changes in a drive voltage and a detection voltage and can stabilize the voltages. In addition, the timing control section thereof forcibly sets liquid crystal video signals to zero level at the generation time of the shield pulse current, thereby being capable of preventing the light emission of the backlight panel due to the shield pulse current from affecting the brightness of the video display apparatus. Furthermore, the failure detection section thereof can monitor the stabilized detection voltage at the generation time of the shield pulse signal by performing comparison in the high level period of the shield pulse signal, thereby being capable of securely detecting the failure state of the backlight panel.

### BRIEF DESCRIPTION OF THE DRAWINGS

FIG. 1A is a block diagram showing a configuration example of a backlight drive apparatus according to a first embodiment of the present invention;

FIG. 1B is a circuit diagram showing a configuration example of a peak value signal generation section according to the first embodiment of the present invention;

FIG. 1C is a circuit diagram showing a configuration example of a transmission pulse signal generation section according to the first embodiment of the present invention;

FIG. 1D is a circuit diagram showing another configuration example of the transmission pulse signal generation section according to the first embodiment of the present invention;

FIG. 1E is a circuit diagram showing a configuration example of a shield pulse signal generation section according to the first embodiment of the present invention;

FIG. 2 is a block diagram showing a configuration example of a video display apparatus according to the first embodiment of the present invention;

FIG. 3 is a timing chart showing the timing states of a total pulse signal generation section according to the first embodiment of the present invention;

FIG. 4 is a waveform diagram showing the waveform states of drive waveforms in the video display apparatus according to the first embodiment of the present invention;

FIG. 5 is an explanatory view showing the waveform state groups of the drive waveforms in a video display apparatus according to Modification example 2 of the first embodiment of the present invention;

FIG. 6 is a waveform diagram showing the waveform states of the drive waveforms in a video display apparatus according to Modification example 3 of the first embodiment of the present invention;

FIG. 7A is a block diagram showing a configuration example of a backlight drive apparatus according to a second embodiment of the present invention;

FIG. 7B is a block diagram showing a configuration example of a total pulse signal generation section according to the second embodiment of the present invention;

FIG. 7C is a block diagram showing a configuration example of a delay pulse signal generation section according to the second embodiment of the present invention;

FIG. 7D is a block diagram showing another configuration example of the delay pulse signal generation section according to the second embodiment of the present invention;

FIG. 7E is a block diagram showing a configuration example of a peak value signal generation section according to the second embodiment of the present invention;

FIG. 8 is a circuit diagram showing a configuration of the backlight drive apparatus according to one of the conventional examples; and

FIG. 9 is a circuit diagram showing a configuration of the backlight drive apparatus according to the other conventional example.

### BEST MODES FOR CARRYING OUT THE INVENTION

Some examples of modes for carrying out the preferred embodiments of the present invention will be described below referring to the accompanying drawings. In the drawings, components representing substantially the same configuration, operation and effect are designated by the same codes. Codes in the drawings are also used in expressions as variable values representing the magnitudes of signals designated by the codes.

### First Embodiment

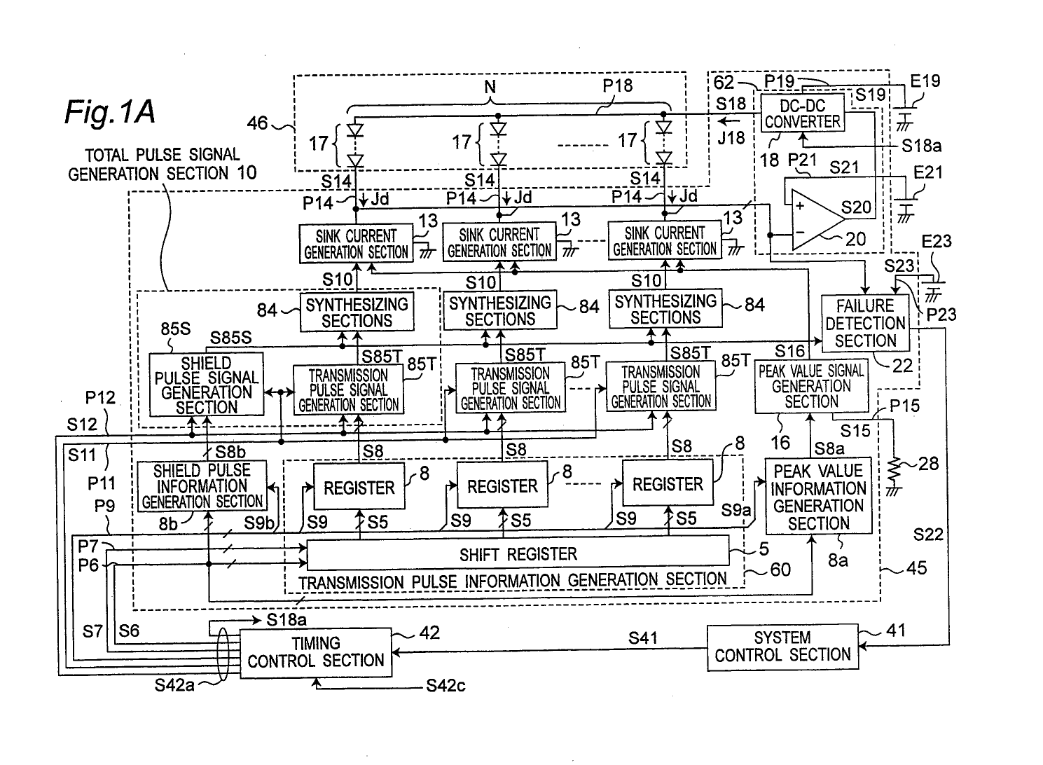

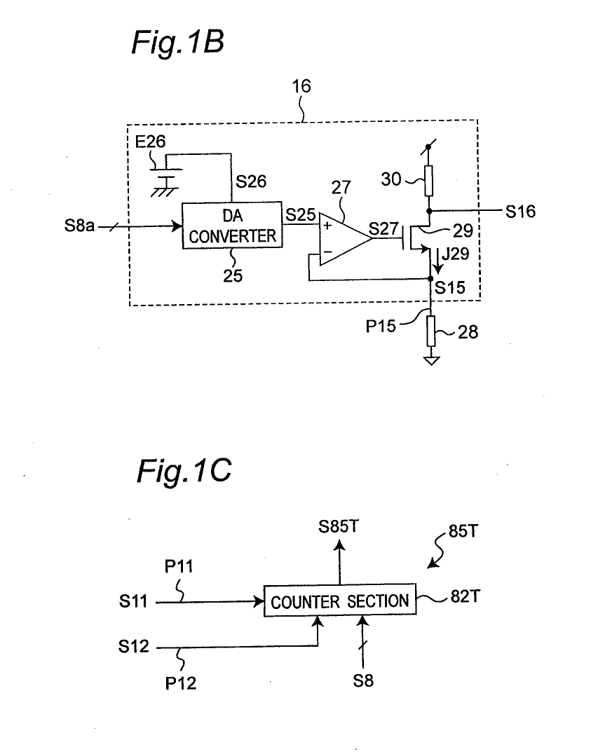

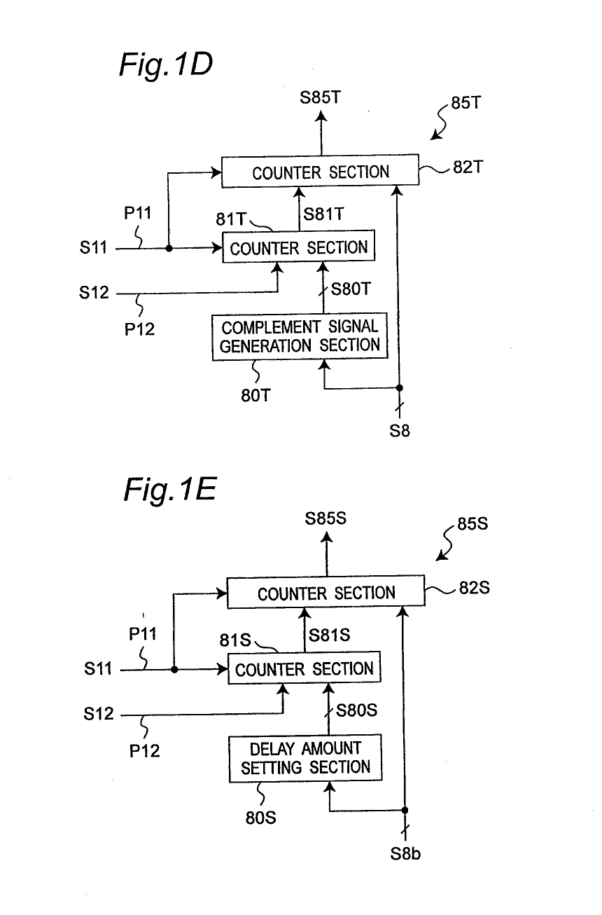

FIG. 1A is a block diagram showing a configuration example of a backlight drive apparatus 45. The backlight drive apparatus 45 includes a drive voltage generation section 62, a failure detection section 22, N (N is an integer of one or more) sink current generation sections 13, N synthesizing sections 84, N transmission pulse signal generation sections 85T, a transmission pulse information generation section 60, one shield pulse signal generation section 85S, a shield pulse information generation section 8b, a peak value signal generation section 16, and a peak value information generation section 8a. The drive voltage generation section 62 includes a DC-DC converter 18 and an error amplification section 20. The transmission pulse information generation section 60 includes N registers 8 and a shift register 5. The configuration shown in FIG. 1A includes a backlight panel 46, a predetermined power source E19, a predetermined power source E21, a predetermined power source E23, a system control section 41 and a timing control section 42, in addition to the backlight drive apparatus 45. The backlight panel 46 includes N strings 17. One string 17 includes one or more light-emitting devices. The light-emitting device is an LED (light-emitting diode), for example.

One terminal of each string 17 is referred to as an anode terminal, and the other terminal thereof is referred to as a cathode terminal. The anode terminals of the N strings 17 are commonly connected to the output path P18 of the DC-DC converter 18, and the cathode terminals thereof are connected to N detection paths P14, respectively. Plural LEDs included in each string 17 are mutually connected in series so that the forward direction from the anode to the cathode is coincident with the direction from the anode terminal (the output path P18) to the cathode terminal (the detection path P14). One terminal of each of the N sink current generation sections 13 is connected to each of the N detection paths P14, and another terminal thereof is grounded.

N connections, each including the string 17, the detection path P14 and the sink current generation section 13 connected mutually in series, are located between the output path P18 and the ground. One string 17, one sink current generation section 13 connected to this string 17, one synthesizing section 84 connected to this sink current generation section 13, one transmission pulse signal generation section 85T connected to this synthesizing section 84 and one register 8 connected to this transmission pulse signal generation section 85T constitutes one string circuit. The configuration shown in FIG. 1A includes N string circuits. Basically, as signals (including voltages and currents) input to and output from these N string circuits, N kinds of signals are available. However, some of the signals are used in common. These N string circuits are basically the same with one another, whereby the N kinds of signals are basically equivalent to one another. Hence, the description can be made essential and simple by assigning the same code to the components of the N string circuits or the N kinds of signals. However, the N string circuits to which the same code is assigned may have operation states different from one another at a time. Hence, the N kinds of signals to which the same code is assigned may have on-duty ratios and level states (high level or low level) different from one another at a time. In the following description, one string circuit and one kind of signal associated with the string circuit will be described unless otherwise specified.

The transmission pulse signal generation section 85T and the synthesizing sections 84 included in one string circuit and the shield pulse signal generation section 85S constitute a total pulse signal generation section 10. The backlight drive apparatus 45 includes N total pulse signal generation sections 10. The N total pulse signal generation sections 10 share one shield pulse signal generation section 85S. In FIG. 1A, only one total pulse signal generation section 10 is shown for easy viewing.

The predetermined power source E19 generates a predetermined voltage S19 on a power source path P19. The DC-DC converter 18 receives the predetermined voltage S19 via the power source path P19 and converts the predetermined voltage S19 into a drive voltage S18. For example, the DC-DC converter 18 raises the predetermined voltage S19, a DC voltage, to the drive voltage S18, an approximately DC voltage. The DC-DC converter 18 generates the drive voltage S18 as described above and supplies the voltage to the N strings 17 via the output path P18. All the loads of the DC-DC converter 18 are circuits in which N connections, each including one string 17 and one sink current generation section 13 being connected to each other in series, are connected in parallel. The DC-DC converter 18 supplies a total sink current J18 based on the drive voltage S18 to all the loads.

The sink current generation section 13 generates a sink current Jd and supplies the sink current Jd to the string 17 via the detection path P14 disposed on the opposite side of the output path P18 with the string 17 interposed therebetween. In a different viewpoint, the string 17 and the sink current generation section 13 connected to each other in series divide the drive voltage S18 and generate a detection voltage S14 on the detection path P14. On the basis of the drive voltage S18, the sink current Jd flows from the output path P18 to the ground via the string 17, the detection path P14 and the sink current generation section 13. The total of the N kinds of sink currents Jd coincides with the total sink current J18. The sink current generation section 13 adjusts the waveform of the sink current Jd to a desired waveform. For example, the sink current generation section 13 pulse-width-modulates (ON/OFF) the sink current Jd at a predetermined PWM (pulse width modulation) cycle and adjusts the magnitude of the sink current Jd at ON time. The PWM cycle is 1/60 to 1/480 second, for example.

The detection voltage S14 has a value between the drive voltage S18 and the ground voltage (i.e., zero volts). In the case that the sink current generation section 13 is in its ON state, the detection voltage S14 lowers due to the voltage drop at the string 17. In the case that the sink current generation section 13 is in its OFF state, the detection voltage S14 becomes close to the drive voltage S18.

The predetermined power source E21 generates a predetermined voltage S21 on a power source path P21. The error amplification section 20 receives the predetermined voltage S21 from the power source path P21 at the non-inverting input terminal thereof and receives the N kinds of detection voltages S14 at the N inverting input terminals thereof. The lowest voltage among the N kinds of detection voltages S14 is referred to as the lowest detection voltage. The error amplification section 20 amplifies the voltage obtained by subtracting the lowest detection voltage from the predetermined voltage S21 and generates an error voltage S20.

The DC-DC converter 18 converts the predetermined voltage S19 into the drive voltage S18 on the basis of the error voltage S20. For example, the DC-DC converter 18 switches the predetermined voltage S19 according to the PWM signal based on a converter control clock S18a and the error voltage S20, and smooths the switched voltage, thereby generating the drive voltage S18. The PWM signal has the clock rate of the converter control clock S18a and an on-duty ratio changing approximately linearly at a positive inclination with respect to the error voltage S20. The on-duty ratio represents the ratio of the ON period to the ON/OFF cycle. For example, the DC-DC converter 18 includes a triangular wave generator and a comparator. The triangular wave generator generates a triangular wave signal at the timing of the converter control clock S18a. The comparator compares the triangular wave signal with the error voltage S20 and generates a PWM signal representing the result of the comparison.

In this case, as the error voltage S20 becomes larger in the positive direction, the DC-DC converter 18 increases the on-duty ratio of the PWM signal and raises the drive voltage S18. On the other hand, as the error voltage S20 becomes larger in the negative direction, the DC-DC converter 18 decreases the on-duty ratio of the PWM signal and lowers the drive voltage S18. In other words, as the lowest detection voltage becomes lower than the predetermined voltage S21, the error amplification section 20 increases the error voltage S20 in the positive direction and the DC-DC converter 18 raises the drive voltage S18, whereby the lowest detection voltage is suppressed from becoming lower. On the other hand, as the lowest detection voltage becomes higher than the predetermined voltage S21, the error amplification section 20 increases the error voltage S20 in the negative direction and the DC-DC converter 18 lowers the drive voltage S18, whereby the lowest detection voltage is suppressed from becoming higher. In this way, the DC-DC converter 18 adjusts the drive voltage S18 so that the lowest detection voltage is nearly equal to the predetermined voltage S21 via a negative feedback path passing through the DC-DC converter 18, the output path P18, the string 17, the detection path P14 and the error amplification section 20. The predetermined voltage S21 is set to the lowest value in a range in which the sink current generation section 13 can adjust the sink current Jd properly. Hence, the sink current generation section 13 can make adjustment so that the sink current Jd has a desired pulse current waveform while power loss is reduced, whereby low power consumption can be attained.

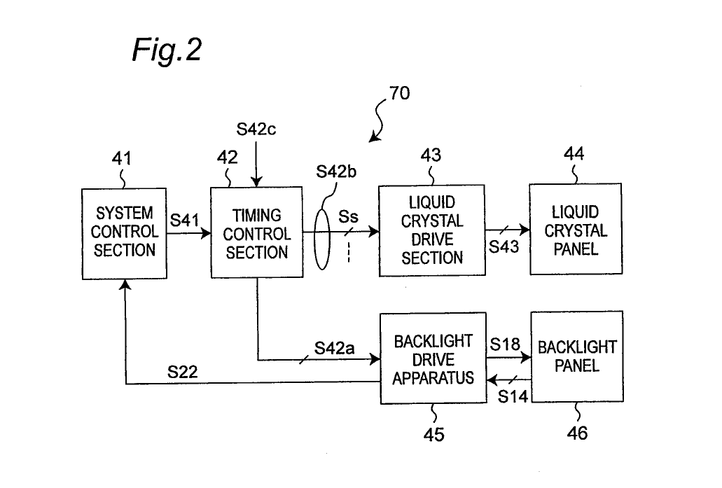

The system control section 41 generates a system control signal S41 for controlling the whole system of the video display apparatus 70 shown in FIG. 2 and described later. The timing control section 42 generates plural kinds of timing control signals S42a on the basis of the system control signal S41 and a video signal S42c. The timing control section 42 generates the timing of the PWM frequency, and the timing is contained in the timing control signals S42a. The system control section 41 is formed of a microcomputer storing programs for generating the system control signal S41. The timing control section 42 is formed of an FPGA (field programmable gate array) in which a circuit for generating the timing control signals S42a is incorporated.

The timing control signals S42a include serial information S6, a shift clock S7, a latch clock S9, a latch clock S9a, a latch clock S9b, a duty master clock S11, a duty output timing signal S12 and the converter control clock S18a. The serial information S6 includes serial transmission pulse information, peak value information and shield pulse information. The serial transmission pulse information includes N pieces of transmission pulse information respectively corresponding to the N kinds of sink currents Jd. The transmission pulse information, the peak value information and the shield pulse information are represented by binary data. The timing control section 42 generates the serial transmission pulse information so that the N pieces of transmission pulse information represented by binary data are arranged in series at each PWM cycle. Furthermore, the timing control section 42 generates the serial transmission pulse information, the peak value information and the shield pulse information at each PWM cycle. As described above, the serial transmission pulse information, the peak value information and the shield pulse information can change at each PWM cycle.

The serial transmission pulse information and the shield pulse information represent information relating to the on-duty ratio of the PWM-modulated sink current Jd with respect to the PWM cycle. The on-duty ratio represents the ratio of the ON period to the PWM cycle. The serial transmission pulse information and the shield pulse information may include information relating to the timing of the PWM-modulated sink current Jd in the PWM cycle and will be detailed later. The peak value represents the pulse height of a pulse signal and the peak value information represents information relating to the pulse height of the PWM-modulated sink current Jd. The serial transmission pulse information and the peak value information can change on the basis of the video signal S42c.

The rising times and the lowering times of the transmission pulse signal S85T and the shield pulse signal S85S (detailed later) generated by the transmission pulse signal generation sections 85T and the shield pulse information generation section 8b, respectively, may change continuously on a time axis or may change discontinuously at a sufficiently small step width in comparison with the PWM cycle. In the case that the rising/lowering time changes discontinuously, the duty master clock S11 represents a clock in which the width of the time change step is used as a cycle. The duty output timing signal S12 represents a clock pulse generated once at predetermined timing at each PWM cycle. For example, the duty output timing signal S12 represents the timing of the start time of each PWM cycle. The timing control section 42 generates the shift clock S7, the respective latch clocks S9, S9a and S9b, and the duty output timing signal S12 on the basis of the duty master clock S11. The latch clocks S9, S9a and S9b represent clock pulses generated once at predetermined timing at each PWM cycle. At least two of the latch clocks S9, S9a and S9b may be the same. Furthermore, the shift clock S7 and the respective latch clocks S9, S9a and S9b may be generated on the basis of the duty master clock S11 or may be generated on the basis of another clock. Still further, the respective latch clocks S9, S9a and S9b may not be generated at least at one PWM cycle or may be generated twice or more at least at one PWM cycle.

The shift register 5 receives, from the timing control section 42, the serial transmission information inside the serial information S6 via a signal path P6 and receives the shift clock S7 via a signal path P7. Furthermore, the shift register 5 transfers the serial transmission pulse information at the timing of N pulses of the shift clock S7 and generates N kinds of transmission pulse information S5 respectively corresponding to the N kinds of sink currents Jd. The N registers 8 receive the latch clock S9 from the timing control section 42 via a signal path P9 and latch (or store) the N kinds of transmission pulse information S5 simultaneously at the timing of the latch clock S9, thereby generating N kinds of transmission pulse information S8. The shift clock S7 is formed of desired pulse groups and is formed of N kinds of pulse groups corresponding to the N kinds of transmission pulse information S8. Hence, the N kinds of transmission pulse information S8 can be made different from one another at each PWM cycle. Furthermore, the respective N kinds of transmission pulse information S8 can change at each PWM cycle. In this way, the transmission pulse information generation section 60 stores the serial transmission pulse information sent from the timing control section 42 and generates the N kinds of transmission pulse information S8.

For example, the latch clock S9 represents the timing of the start time of each PWM cycle. The N kinds of registers 8 latch the N kinds of transmission pulse information S5 simultaneously at the start time of one PWM cycle. The shift register 5 transfers the serial transmission pulse information in the period from the start time to the end time of this PWM cycle. At the start time of the subsequent PWM cycle, the N kinds of registers 8 simultaneously latch the N kinds of transmission pulse information S5 based on the transferred serial transmission pulse information. In this way, the transmission pulse information generation section 60 can generate the N kinds of transmission pulse information S8 on the basis of the serial transmission pulse information sent from the timing control section 42 by means of pipe line processing in units of PWM cycle.

The peak value information generation section 8a receives the peak value information inside the serial information S6 via the signal path P6 and receives the latch clock S9a via the signal path P9 from the timing control section 42. Furthermore, the peak value information generation section 8a latches (or stores) the peak value information at the timing of the latch clock S9a and generates peak value information S8a. As described above, the latch clock S9a is output once at each PWM cycle. Hence, the peak value information S8a can change at each PWM cycle.

The shield pulse information generation section 8b receives the shield pulse information inside the serial information S6 via the signal path P6 and receives the latch clock S9b via the signal path P9 from the timing control section 42. Furthermore, the shield pulse information generation section 8b latches (or stores) the shield pulse information at the timing of the latch clock S9b and generates shield pulse information S8b. The latch clock S9b is output once at each PWM cycle as described above. Hence, the shield pulse information S8b can change at each PWM cycle.

The transmission pulse signal generation sections 85T receives the duty master clock S11 via a signal path P11 and receives the duty output timing signal S12 via a signal path P12 from the timing control section 42. The transmission pulse signal generation sections 85T fetches one kind of transmission pulse information S8 associated with the same string circuit from among the N kinds of transmission pulse information S8 at the timing associated with the duty output timing signal S12. The transmission pulse signal generation sections 85T generates the transmission pulse signal generation sections 85T representing one pulse signal having an on-duty ratio based on the transmission pulse information S8 at each PWM cycle of the duty output timing signal S12. The transmission pulse information generation section 60 and the transmission pulse signal generation sections 85T can generate the transmission pulse signals S85T representing the individual on-duty ratios of the N strings 17 on the basis of the serial transmission pulse information inside the serial information S6.

The shield pulse signal generation section 85S receives the duty master clock S11 via the signal path P11 and receives the duty output timing signal S12 via the signal path P12 from the timing control section 42. The shield pulse signal generation section 85S fetches the shield pulse information S8b at the timing associated with the duty output timing signal S12. The shield pulse signal generation section 85S generates the shield pulse signal S85S representing one pulse signal having an on-duty ratio based on the shield pulse information S8b at each PWM cycle of the duty output timing signal S12.

The synthesizing section 84 synthesizes one transmission pulse signal S85T and one shield pulse signal S85S and generates a total pulse signal S10. For example, the synthesizing section 84 generates the total pulse signal S10 representing the logical OR of the transmission pulse signal S85T and the shield pulse signal S85S. As described above, the total pulse signal generation section 10 generates the total pulse signal S10 including one transmission pulse signal S85T having the on-duty ratio based on the transmission pulse information S8 and one shield pulse signal S85S having the on-duty ratio based on the shield pulse information S8b at each PWM cycle.

Next, further detailed configuration examples of the transmission pulse signal generation sections 85T and the shield pulse signal generation section 85S will be described below. In one example, the transmission pulse signal generation sections 85T includes a counter section 82T as shown in FIG. 1C. The counter section 82T fetches the transmission pulse information S8 at the timing of the duty output timing signal S12. At the same time, the counter section 82T starts counting the pulses of the duty master clock S11 and changes the level of the transmission pulse signal S85T from low to high. The counter section 82T counts the pulses of the duty master clock S11 during a period corresponding to the pulse width having the on-duty ratio based on the transmission pulse information S8 and changes the level of the transmission pulse signal S85T from high to low when the counting is completed. The transmission pulse information S8 may be the number of the pulses of the duty master clock S11 corresponding to the pulse width having the on-duty ratio.

As described above, the PWM cycle is 1/60 to 1/480 second, for example. In this case, the frequency of the duty output timing signal S12 is 60 to 480 Hz. For example, in the case that the PWM cycle is aligned with a 12-bit counter cycle, the frequency of the duty master clock S11 is (60 to 480 Hz)×4096, approximately 0.25 to 2 MHz.

In another example, the transmission pulse signal generation sections 85T includes a complement signal generation section 80T, a counter section 81T and the counter section 82T as shown in FIG. 1D. The complement signal generation section 80T generates a complement signal S80T representing the complement of the transmission pulse information S8. The complement signal S80T represents a period obtained by subtracting the pulse width having the on-duty ratio based on the transmission pulse information S8 from the PWM cycle, for example. The counter section 81T fetches the complement signal S80T at the timing of the duty output timing signal S12. At the same time, the counter section 81T starts counting the pulses of the duty master clock S11 and changes the level of a counting result signal S81T representing the result of the counting from low to high. The counter section 81T counts the pulses of the duty master clock S11 during a period based on the complement signal S80T and changes the level of the counting result signal S81T from high to low when the counting is completed. The counter section 82T fetches the transmission pulse information S8 at the lowering timing of the counting result signal S81T. At the same time, the counter section 82T starts counting the pulses of the duty master clock S11 and changes the level of the transmission pulse signal S85T from low to high. The counter section 82T counts the pulses of the duty master clock S11 during the period corresponding to the pulse width having the on-duty ratio based on the transmission pulse information S8 and changes the level of the transmission pulse signal S85T from high to low when the counting is completed.

The shield pulse signal generation section 85S includes a delay amount setting section 80S, a counter section 81S and a counter section 82S as shown in FIG. 1E, for example. The delay amount setting section 80S generates a delay amount signal S80S representing the delay amount of the shield pulse signal S85S from the timing of the duty output timing signal S12. In FIG. 1E, the delay amount setting section 80S sets the delay amount signal S80S to a predetermined value in advance. However, it may be possible that the shield pulse information S8b includes information relating to the timing in the PWM cycle and that the delay amount setting section 80S generates the delay amount signal S80S on the basis of the shield pulse information S8b as described above. The counter section 81S fetches the delay amount signal S80S at the timing of the duty output timing signal S12. At the same time, the counter section 81S starts counting the pulses of the duty master clock S11 and changes the level of a counting result signal S81S representing the result of the counting from low to high. The counter section 81S counts the pulses of the duty master clock S11 during a period corresponding to the delay amount based on the delay amount signal S80S and changes the level of the counting result signal S81S from high to low when the counting is completed. The counter section 82S fetches the shield pulse information S8b at the lowering timing of the counting result signal S81S. At the same time, the counter section 82S starts counting the pulses of the duty master clock S11 and changes the level of the shield pulse signal S85S from low to high. The counter section 82S counts the pulses of the duty master clock S11 during a period corresponding to the pulse width having the on-duty ratio based on the shield pulse information S8b and changes the level of the shield pulse signal S85S from high to low when the counting is completed. The shield pulse information S8b may be the number of the pulses of the duty master clock S11 corresponding to the pulse width having the on-duty ratio.

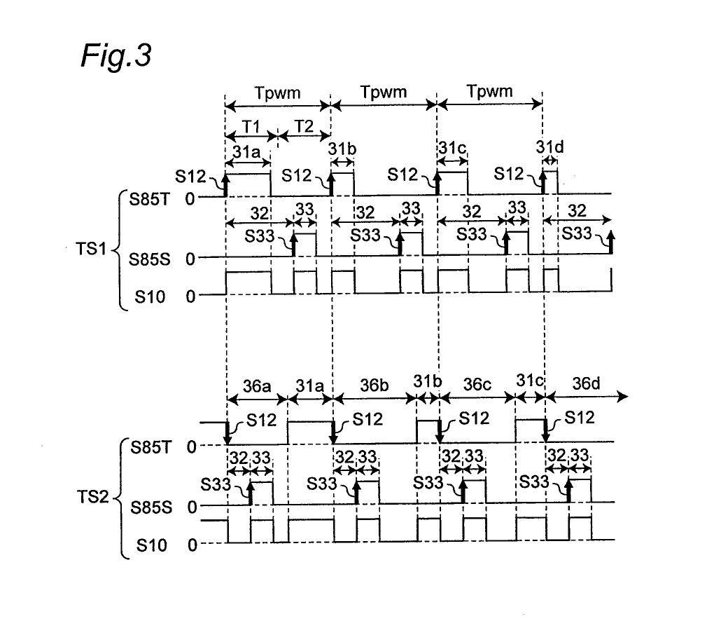

FIG. 3 is a timing chart schematically showing examples of the timing states of the total pulse signal generation section 10. The horizontal axis is divided into units of PWM cycle Tpwm. The PWM cycle Tpwm is divided into two equal parts. The first half is referred to as a first half period T1 and the second half is referred to as a second half period T2. At a timing state TS1, the transmission pulse signal S85T is generated by the transmission pulse signal generation sections 85T shown in FIG. 1C. The transmission pulse signal S85T becomes high level after the start time of the PWM cycle Tpwm on the basis of the rising timing of the duty output timing signal S12 and becomes low level after high level periods 31a, 31b, 31c and 31d having on-duty ratios of 50% or less based on the transmission pulse information S8 have passed. The shield pulse signal S85S is generated by the shield pulse signal generation section 85S shown in FIG. 1E. The shield pulse signal S85S becomes high level after a predetermined low-level period 32 (corresponding to the high-level period of the counting result signal S81S) from the start time of the PWM cycle Tpwm has passed and becomes low level after a high level period 33 having a predetermined on-duty ratio of 50% or less based on the shield pulse information S8b has passed. The total pulse signal S10 is the logical OR signal of the transmission pulse signal S85T and the shield pulse signal S85S. As described above, in the timing state TS1, the total pulse signal S10 includes the transmission pulse signal S85T in the first half period T1 and includes the shield pulse signal S85S in the second half period T2.

At a timing state TS2, the transmission pulse signal S85T is generated by the transmission pulse signal generation sections 85T shown in FIG. 1D. The transmission pulse signal S85T becomes high level after low level periods 36a, 36b, 36c and 36d (corresponding to the high-level period of the counting result signal S81T) have passed from the start time of the PWM cycle Tpwm based on the lowering timing of the duty output timing signal S12. Then, the transmission pulse signal S85T becomes low level after the high level periods 31a, 31b, 31c and 31d having on-duty ratios of 50% or less based on the transmission pulse information S8 have passed and the end time of the PWM cycle Tpwm has been reached. The shield pulse signal S85S is generated by the shield pulse signal generation section 85S shown in FIG. 1E. The shield pulse signal S85S becomes high level after the predetermined low-level period 32 (corresponding to the high-level period of the counting result signal S81S) from the start time of the PWM cycle Tpwm has passed and becomes low level after the high level period 33 having a predetermined on-duty ratio of 50% or less based on the shield pulse information S8b has passed. The total pulse signal S10 is the logical OR signal of the transmission pulse signal S85T and the shield pulse signal S85S. As described above, in the timing state TS2, the total pulse signal S10 includes the shield pulse signal S85S in the first half period T1 and includes the transmission pulse signal S85T in the second half period T2.

In the respective timing states TS1 and TS2, the shield pulse signal S85S corrects the time imbalance of the transmission pulse signal S85T. As a result, the total pulse signal S10 is equalized with respect to time.

In another configuration of the total pulse signal generation section 10, the total pulse signal generation section 10 is formed of a microcomputer storing programs for generating the total pulse signal generation section 10.

In the case that the total pulse signal generation section 10 is formed of a single shot multivibrator or a microcomputer, the timing values of the above-mentioned transmission pulse signal S85T in the timing states TS1 and TS2 are all set according to the timing information of the transmission pulse information S8. Furthermore, the low-level period 32 of the shield pulse signal S85S is set according to the timing information of the shield pulse information S8b.

As shown in FIG. 1B, the peak value signal generation section 16 includes a DA converter 25, a reference power source E26, an operational amplifier 27, a transistor 29 and a resistor 30. The drain of the transistor 29 is connected to a power source via the resistor 30, the source thereof is grounded via a signal path P15 and a resistor 28, and the gate thereof is connected to the output terminal of the operational amplifier 27. The DA converter 25 converts digital data represented by the peak value information S8a into an analog level S25 adjusted on the basis of a reference voltage S26 supplied from the reference power source E26. The operational amplifier 27 receives the analog level S25 at the non-inverting input terminal and receives a source voltage S15 on the signal path P15 at the inverting input terminal, and generates a gate voltage S27 proportional to the value obtained by subtracting the source voltage S15 from the analog level S25. In the case that the product of the amplification factor of the operational amplifier 27 and the mutual conductance of the transistor 29 is sufficiently large, the source voltage S15 becomes approximately equal to the analog level S25. As described above, the peak value signal generation section 16 generates a drain current J29 obtained by dividing the analog level S25 by the resistance of the resistor 28, converts the drain current J29 into a voltage at the resistor 30, and generates a peak value signal S16 corresponding to the peak value information S8a at the drain of the transistor 29. The peak value signal S16 represents the peak value of the sink current Jd. As the analog level S25 obtained by decoding the peak value information S8a becomes higher, the peak value signal generation section 16 lowers the level of the peak value signal S16, and as the analog level S25 becomes lower, the peak value signal generation section 16 raises the level of the peak value signal S16. The peak value serving as the reference of the sink current Jd can be set according to the resistance of the resistor 28. As described above, the peak value signal generation section 16 generates the peak value signal S16 representing the peak value of the sink current Jd on the basis of the peak value information S8a.

The sink current generation section 13 generates the sink current Jd by drawing the sink current Jd from the string 17 on the basis of one kind of total pulse signal S10 associated with the same string circuit among the N kinds of total pulse signals S10 and makes adjustment so that the light of the string 17 has a desired intensity. The sink current generation section 13 adjusts the magnitude of the sink current Jd in particular. In the case that the total pulse signal S10 is high level, the sink current generation section 13 adjusts the sink current Jd to the peak value represented by the peak value signal S16, and in the case that the total pulse signal S10 is low level, the sink current generation section 13 adjusts the sink current Jd to approximately zero amperes. As described above, the sink current generation section 13 adjusts the on-duty ratio of the sink current Jd on the basis of the total pulse signal S10 and adjusts the peak value of the sink current Jd on the basis of the peak value signal S16, thereby being capable of adjusting the light of the string 17. The sink current Jd includes a transmission pulse current corresponding to the transmission pulse signal S85T and a shield pulse current corresponding to the shield pulse signal S85S. In the case that the transmission pulse signal S85T is high level, the transmission pulse current has the magnitude of the peak value signal S16, and in the case that the transmission pulse signal S85T is low level, the transmission pulse current is approximately zero amperes. In the case that the shield pulse signal S85S is high level, the shield pulse current has the magnitude of the peak value signal S16, and in the case that the shield pulse signal S85S is low level, the shield pulse current is approximately zero amperes. In other words, the on-duty ratio of the transmission pulse current is equal to the on-duty ratio of the transmission pulse signal S85T, and the on-duty ratio of the shield pulse current is equal to the on-duty ratio of the shield pulse signal S85S.

The predetermined power source E23 generates a predetermined voltage S23 on a power source path P23. The failure detection section 22 receives the predetermined voltage S23 from the power source path P23 and receives the N kinds of detection voltages S14. Furthermore, the failure detection section 22 receives the shield pulse signals S85S from the N total pulse signal generation sections 10. The failure detection section 22 compares the N kinds of detection voltages S14 with the predetermined voltage S23 in a period in which the shield pulse signal S85S is high level. When at least one kind of detection voltage among the N kinds of detection voltages S14 becomes higher than the predetermined voltage S23, the failure detection section 22 generates a failure detection signal S22 (high level, for example). In the other cases, the failure detection section 22 does not generate the failure detection signal S22 (maintained to low level, for example). The failure detection section 22 may compare the highest voltage of the N kinds of detection voltages S14 with the predetermined voltage S23 or may compare all the N kinds of detection voltages S14 with the predetermined voltage S23. Furthermore, the failure detection section 22 may include the identification information of the string 17 corresponding to the detection voltage S14 having become higher than the predetermined voltage S23 in the failure detection signal S22.

A minimum forward drop voltage herein represents the minimum voltage in the variation range of the forward drop voltages of the LEDs constituting the backlight panel 46. In this case, the predetermined voltage S23 is set to a voltage obtained by multiplying the minimum forward drop voltage of one LED by a predetermined margin ratio and by adding the result of the multiplication to the predetermined voltage S21. In the case that the number of the LEDs included in one string 17 is relatively small, the predetermined margin ratio is 80% or more and less than 100%, for example. In the normal state, among the N kinds of detection voltages S14, the lowest detection voltage becomes approximately equal to the predetermined voltage S21 as described above. Among the N kinds of detection voltages S14, the voltages other than the lowest detection voltage are higher than the lowest detection voltage but lower than the voltage obtained by adding the minimum forward drop voltage to the lowest detection voltage. However, if at least one LED is short-circuited, the detection voltage S14 corresponding to the string 17 including the LED being in the short-circuit state becomes a voltage not less than the voltage obtained by adding the minimum forward drop voltage to the lowest detection voltage. Hence, if at least one LED inside the backlight panel 46 is short-circuited, the failure detection section 22 can generate the failure detection signal S22. Furthermore, in the case that the number of the LEDs included in one string 17 is relatively large, the above-mentioned predetermined margin ratio may be set to 100% or more, for example. In this case, if the LEDs included in one string 17, the number of which corresponds to the margin ratio having been set as described above, are short-circuited, the failure detection section 22 generates the failure detection signal S22.

The detection of the short-circuit state of an LED has been described above. The detection of the disconnection state of an LED will be described below. The failure detection section 22 may include a voltage divider so that the voltage divider divides the predetermined voltage S23 to generate a predetermined divided voltage. In this case, the failure detection section 22 compares the N kinds of detection voltages S14 with the predetermined divided voltage in a period in which the shield pulse signal S85S is high level. When at least one kind of detection voltage among the N kinds of the detection voltages S14 becomes lower than the predetermined divided voltage, the failure detection section 22 generates the failure detection signal S22 (high level, for example). In the other cases, the failure detection section 22 does not generate the failure detection signal S22 (maintained to low level, for example). The failure detection section 22 may compare the lowest voltage of the N kinds of detection voltages S14 with the predetermined divided voltage or may compare all the N kinds of the detection voltages S14 with the predetermined divided voltage. Furthermore, the failure detection section 22 may include the identification information of the string 17 corresponding to the detection voltage S14 having become lower than the predetermined divided voltage in the failure detection signal S22.

The predetermined divided voltage is set so as to be lower than the predetermined voltage S21 and higher than the ground voltage. In the normal state, the lowest detection voltage becomes approximately equal to the predetermined voltage S21. However, if the conduction of at least one LED is cut off (the LED is in a disconnection state), the detection voltage S14 corresponding to the string 17 including the LED being in the cut-off state becomes the ground voltage. Hence, if at least one LED inside the backlight panel 46 becomes the cut-off state, the failure detection section 22 can generate the failure detection signal S22.

The failure detection section 22 may compare the N kinds of detection voltages S14 with both the predetermined voltage S23 and the predetermined divided voltage in the period in which the shield pulse signal S85S is high level. The failure detection section 22 generates the failure detection signal S22 if at least one kind of detection voltage among the N kinds of detection voltages S14 becomes higher than the predetermined voltage S23 or becomes lower than the predetermined divided voltage. The failure detection signal S22 is a two-bit signal, for example, and can represent a short-circuit state, a cut-off state and a non-failure state. In the case that at least one kind of detection voltage becomes higher than the predetermined voltage S23, the failure detection section 22 sets the failure detection signal S22 to the short-circuit state, and in the case that the detection voltage becomes lower than the predetermined divided voltage, the failure detection section 22 sets the failure detection signal S22 to the cut-off state. With this configuration, if at least one LED inside the backlight panel 46 becomes the failure state including the short-circuit state and the cut-off state, the failure detection section 22 can generate the failure detection signal S22.

When the failure detection signal S22 is generated, the system control section 41 performs various kinds of failure countermeasures. The system control section 41 outputs, for example, a failure notification signal (not shown) for notifying the failure state of the backlight panel 46. The system control section 41, for example, instructs the timing control section 42 to stop the shift clock S7, the latch clocks S9, S9a and S9b, the duty master clock S11, the duty output timing signal S12 and the converter control clock S18a via the system control signal S41, thereby stopping the operation of the backlight drive apparatus 45. As a result, the safety of the video display apparatus 70 can be improved.

As described above, the backlight drive apparatus 45 can set an individual on-duty ratio for each of the N strings 17 at each PWM cycle Tpwm. Furthermore, the backlight drive apparatus 45 inputs the individual on-duty ratio and the peak value of the sink current Jd via the serial information S6 having a binary data format, whereby the light of the backlight panel 46 can be adjusted.

FIG. 2 is a block diagram showing a configuration example of the video display apparatus 70. The video display apparatus 70 includes the system control section 41, the timing control section 42, a liquid crystal drive section 43, a liquid crystal panel 44, the backlight drive apparatus 45 and the backlight panel 46. The system control section 41, the timing control section 42, the backlight drive apparatus 45 and the backlight panel 46, and the signals to be exchanged among these components are as described above referring to FIG. 1A.

In the entire video display region of the liquid crystal panel 44, the region illuminated by each of the N strings 17 is referred to as a string region. The entire video display region of the liquid crystal panel 44 can be divided into N string regions. The N string regions respectively correspond to the N strings 17 on one-to-one basis. The video signal S42c can be represented by a reference video signal and a liquid crystal video signal Ss. The reference video signal represents the reference level of the video signal S42c corresponding to each string region at each PWM cycle Tpwm. The reference video signal has a predetermined level for each string region at each PWM cycle Tpwm and can change at each PWM cycle Tpwm and for each string region. For example, the reference video signal is set to the maximum value of the video signal S42c at each PWM cycle Tpwm and in each string region.

The reference video signal represents the reference level of the video signal S42c corresponding to each string region at each PWM cycle Tpwm. On the other hand, the liquid crystal video signal Ss represents a signal that is set for each of plural video samples in each string region on the basis of the video signal S42c. One video sample may be one pixel or one red, green or blue dot in one pixel. The liquid crystal video signal Ss has a desired level for each video sample at each PWM cycle Tpwm and can change for each video sample at each PWM cycle Tpwm. The liquid crystal video signal Ss represents a signal uniquely obtained for each video sample at each PWM cycle Tpwm from the video signal S42c and the reference video signal. The liquid crystal video signal Ss is a signal obtained by normalizing the video signal S42c with respect to the reference level represented by the reference video signal. The liquid crystal video signal Ss increases monotonically as the video signal S42c increases, and decreases monotonically as the video signal S42c decreases. For example, the liquid crystal video signal Ss represents a signal obtained by dividing the video signal S42c by the reference video signal for each video sample and by subjecting the obtained signal to gamma correction.

The timing control section 42 generates a timing control signals S42b including the liquid crystal video signal Ss on the basis of the system control signal S41 and the video signal S42c. The liquid crystal drive section 43 generates drive signals S43 on the basis of the timing control signals S42b. The liquid crystal drive section 43 drives the liquid crystal panel 44 on the basis of the drive signals S43 so that the light transmittance of each video sample has a value approximately proportional to the liquid crystal video signal Ss. On the other hand, the timing control section 42 generates serial transmission pulse information and peak value information on the basis of the reference video signal. For example, with respect to the serial transmission pulse information, the timing control section 42 performs control so that the transmission pulse information S8 of the string corresponding to the reference video signal has an on-duty ratio approximately proportional to the reference video signal. The total pulse signal generation section 10 sets the on-duty ratio of the transmission pulse signal S85T in the total pulse signal S10 to a value approximately proportional to the reference video signal. The sink current generation section 13 sets the on-duty ratio of the sink current Jd to a value approximately proportional to the reference video signal. Hence, the backlight drive apparatus 45 drives the backlight panel 46 on the basis of the drive voltage S18 and sets the light amount (also referred to as light flux or luminance) of the string 17 to a value approximately proportional to the reference video signal.

As described above, the light amount of one string 17 is approximately proportional to the reference video signal, and the light transmittance of each video sample in a string region corresponding to this string 17 is approximately proportional to the liquid crystal video signal Ss. The brightness of each video sample is approximately proportional to the product of the light amount of the string 17 and the light transmittance of this video sample. Hence, the light amount of the string 17 and the light transmittance of each video sample in a string region corresponding thereto can be changed in conjunction with each other by changing the ratio of the reference video signal and the liquid crystal video signal Ss while the value of the video signal S42c, i.e., the brightness of the video sample, is maintained. For example, the light amount of the backlight panel 46 can be adjusted in units of the string 17 by reducing the light amount of the string 17 by a predetermined amount and by increasing the light transmittance of each video sample in the string region corresponding to the string 17 without impairing the reproducibility of the brightness information in the video signal S42c. Hence, it is possible to attain low power consumption and high picture quality, such as high brightness and high contrast.

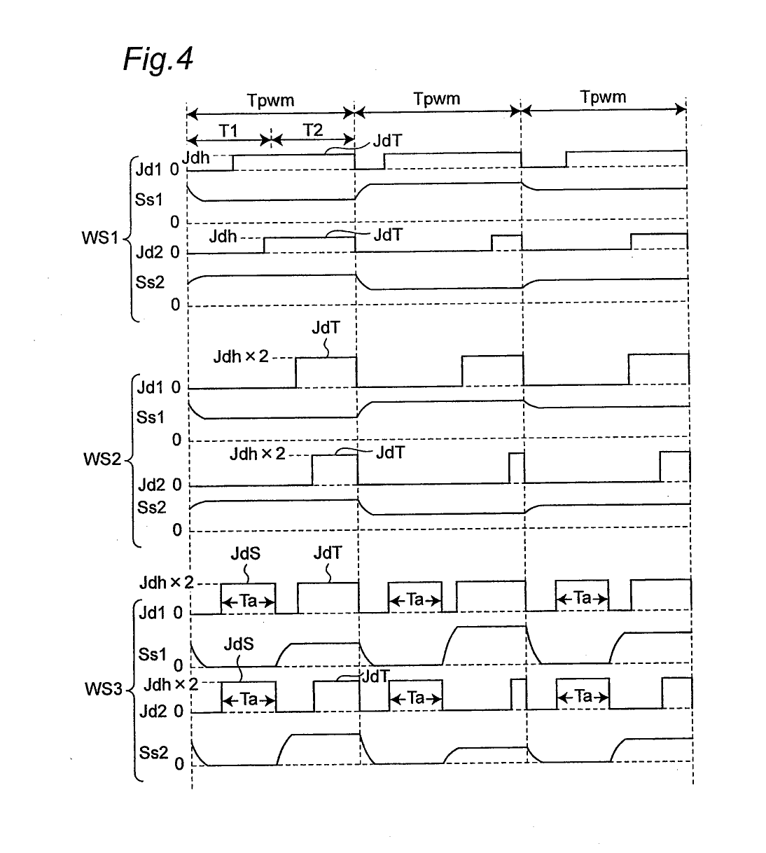

FIG. 4 is a waveform diagram schematically showing examples of the waveform states of drive waveforms for the backlight panel 46 and the liquid crystal panel 44. Sink currents Jd1 and Jd2 flowing through either two of the N strings 17 and liquid crystal video signal Ss1 and Ss2 respectively included in two string regions corresponding to these two strings 17 are indicated in each of waveform states WS1, WS2 and WS3. Each broken line in the diagram indicates a zero level, and the horizontal axis is divided in units of PWM cycle Tpwm.

In the waveform state WS1, the maximum on-duty ratios of the sink currents Jd1 and Jd2 can be set to 100%. The high level period of the liquid crystal video signal Ss1 includes the high level period of the sink current Jd1, and the high level period of the liquid crystal video signal Ss2 includes the high level period of the sink current Jd2. Hence, the light amounts of the strings 17 due to the respective sink currents Jd1 and Jd2 contribute to the brightness values of video samples corresponding to the liquid crystal video signals Ss1 and Ss2 completely. The brightness of each of the video samples respectively corresponding to the liquid crystal video signal Ss1 and Ss2 can be obtained by subjecting the product of each of the liquid crystal video signals Ss1 and Ss2 and each of the sink currents Jd1 and Jd2 to time averaging in units of PWM cycle Tpwm. The sink currents Jd1 and Jd2 corresponding to the high level periods indicate the transmission pulse currents JdT having a peak value Jdh.

When the waveform state WS2 is compared with the waveform state WS1, the waveforms of the liquid crystal video signal Ss1 and Ss2 are maintained without change. The peak values of the sink currents Jd1 and Jd2 are doubled (Jdh×2) in comparison with the peak value Jdh in the case of the waveform state WS1, and the on-duty ratios thereof are halved. The maximum on-duty ratios of the sink currents Jd1 and Jd2 can be set to 50. As a result, the low level periods of the sink currents Jd1 and Jd2 become long in comparison with the low level periods in the waveform state WS1. Hence, the brightness values of the respective video samples corresponding to the liquid crystal video signal Ss1 and Ss2 become approximately equal to the brightness values in the waveform state WS1. As described above, in the waveform state WS2, the sink currents Jd1 and Jd2 become the transmission pulse currents JdT having the peak value of (Jdh×2) and having on-duty ratios halved in comparison the on-duty ratios in the case of the waveform state WS1.

In the first half period T1, the sink currents Jd1 and Jd2 are shut off or blanked. In other words, the first half period T1 corresponds to a blanking period (or a black insertion period) during the double speed drive of the liquid crystal panel 44. Since the residual image of an image displayed on the liquid crystal panel 44 can be suppressed more effectively in the waveform state WS2 than in the waveform state WS1, the waveform state WS2 is suited for displaying quick moving images.

In the waveform state WS3, as in the waveform state WS2, the maximum on-duty ratios of the sink currents Jd1 and Jd2 can be set to 50%. In the low level periods of the sink currents Jd1 and Jd2, longer than the low level periods in the waveform state WS1, the sink currents Jd1 and Jd2 having the peak value (Jdh×2) flow during a predetermined shield lighting period Ta at each PWM cycle Tpwm. The shield lighting period Ta is set so that an on-duty ratio of 40% (Ta=Tpwm×0.4) is obtained at all times, for example. Furthermore, the timing control section 42 sets the liquid crystal video signals Ss1 and Ss2 to a predetermined level or less, for example, approximately zero level, during the shield lighting period Ta by changing the liquid crystal video signals Ss1 and Ss2 at each PWM cycle Tpwm. For example, the timing control section 42 forcibly sets the liquid crystal video signals Ss1 and Ss2 to zero level in the first half period T1 as in the waveform state WS3. Hence, the brightness values of the respective video samples corresponding to the liquid crystal video signal Ss1 and Ss2 become approximately equal to the brightness values in the waveform states WS1 and WS2.

The sink currents Jd1 and Jd2 corresponding to the shield lighting period Ta indicate shield pulse currents JdS having an on-duty ratio of 40%, for example. In other words, the sink current generation section 13 makes adjustment so that the sink current Jd includes one transmission pulse current JdT and one shield pulse current JdS at each PWM cycle Tpwm. When it is assumed that the peak value signal S16 is unchanged, the sink current generation section 13 makes adjustment so that the sink currents Jd1 and Jd2 have values proportional to the total pulse signal S10. In other words, the sink current generation section 13 makes adjustment so that the sink current Jd includes the transmission pulse current JdT proportional to the transmission pulse signal S85T and the shield pulse current JdS proportional to the shield pulse signal S85S.

In the waveform state WS3, the shield pulse current JdS corrects the time imbalance of the transmission pulse current JdT. Hence, the sink currents Jd1 and Jd2 are balanced with respect to time.

In the three kinds of waveform states WS1 to WS3, the maximum change rate of the total sink current J18 output from the DC-DC converter 18 to the N strings 17 will be described herein. In the waveform state WS1, when the on-duty ratios of all the N kinds of sink currents Jd change simultaneously from approximately 0% to approximately 100%, the total sink current J18 changes from zero amperes to (Jdh×100%×N). In the waveform state WS2, when the on-duty ratios of all the N kinds of sink currents Jd change simultaneously from approximately 0% to approximately 50%, the total sink current J18 changes from zero amperes to (Jdh×2×50%×N). This indicates that the maximum change ratio in the waveform state WS2 is equal to that in the waveform state WS1. In the waveform state WS3, when the on-duty ratios of all the N kinds of sink currents Jd change simultaneously from approximately 0% to approximately 50%, the total sink current J18 changes from (Jdh×2×40%×N) to (Jdh×2×90%×N).

The maximum change ratio of the total sink current J18 with respect to the change in the on-duty ratio is infinite in the waveform states WS1 and WS2 but is more than twice at most in the waveform state WS3. In the case of the waveform states WS1 and WS2, overshoot and undershoot occur in the drive voltage S18 because of the large change in the total sink current J18. As a result, the detection voltage S14 changes significantly. Hence, even if the LEDs inside the backlight panel 46 are not faulty, the failure detection section 22 generates the failure detection signal S22 and incorrectly detects the failure state of the backlight panel 46. In the case of the waveform state WS3, the maximum change ratio of the total sink current J18 is far smaller than those in the cases of the waveform states WS1 and WS2. Hence, the changes in the drive voltage S18 and the detection voltage S14 are sufficiently small, and the drive voltage S18 and the detection voltage S14 can be stabilized. Therefore, the failure detection section 22 can generate the failure detection signal S22 only in the case that the LEDs inside the backlight panel 46 are faulty, thereby being capable of securely detecting the failure state of the backlight panel 46.

In the case that the brightness of the video signal S42c changes significantly inside a screen with respect to time, when operation is carried out as in the waveform states WS1 and WS2, the number of the strings 17 being in the ON state and the on-duty ratio change significantly. However, when the shield lighting period Ta is inserted and operation is carried out as in the waveform state WS3, the sink current Jd can be passed intermittently and sufficiently at all times. Hence, the flow of the sink current Jd is stabilized, and the change in the drive voltage S18 can be suppressed eventually. Moreover, since the liquid crystal video signals Ss1 and Ss2 are forcibly set to zero level in the shield lighting period Ta, the light emission of the backlight panel 46 in the shield lighting period Ta does not affect the brightness of the video display apparatus 70. Furthermore, the failure detection section 22 can monitor the sink currents Jd that is stable in the shield lighting period Ta by comparing the detection voltage S14 with the predetermined voltage S23 in the shield lighting period Ta, thereby being capable of securely detecting the failure state of the backlight panel 46.

The system control section 41 includes a timer for measuring a predetermined period and may measure the high level state of the failure detection signal S22 during the predetermined period. In the case that the failure detection signal S22 becomes low level before the expiration of the predetermined period, the system control section 41 resets the timer and restarts the time measurement. On the other hand, in the case that the high level state of the failure detection signal S22 is maintained during the predetermined period, the system control section 41 judges that the backlight panel 46 is faulty. In this case, the system control section 41 can prevent malfunction due to instantaneous noise in the failure detection section 22 by allowing the timer to measure the time of the high level state of the failure detection signal S22.

As described above, with the backlight drive apparatus 45 and the video display apparatus 70 according to the first embodiment, the total pulse signal generation section 10 generates the total pulse signal S10 including one transmission pulse signal S85T and one shield pulse signal S85S at each PWM cycle Tpwm. Furthermore, the sink current generation section 13 can adjust the sink current Jd to the transmission pulse current JdT corresponding to the transmission pulse signal S85T and to the shield pulse current JdS corresponding to the shield pulse signal S85S. Hence, the backlight drive apparatus 45 balances the sink currents Jd respectively flowing through the N strings 17 with respect to time to lower the dependency on the video signal S42c, thereby being capable of reducing the change in the total sink current J18. As a result, the backlight drive apparatus 45 can suppress the changes in the drive voltage S18 and the detection voltage S14 and can stabilize the voltages. In addition, the timing control section 42 forcibly sets the liquid crystal video signals Ss1 and Ss2 to zero level at the generation time of the shield pulse current JdS, thereby being capable of preventing the light emission of the backlight panel 46 due to the shield pulse current JdS from affecting the brightness of the video display apparatus 70. Furthermore, the failure detection section 22 can monitor the stabilized detection voltage S14 at the generation time of the shield pulse signal S85S by performing comparison in the high level period of the shield pulse signal S85S, thereby being capable of securely detecting the failure state of the backlight panel 46.

### Modification Example 1 of the First Embodiment

In the first embodiment, as described above referring to FIG. 1A, the backlight drive apparatus 45 includes the N total pulse signal generation sections 10, and the N total pulse signal generation sections 10 share one shield pulse signal generation section 85S. In Modification example 1 of the first embodiment, each of the N total pulse signals S10 includes a shield pulse signal generation section having the same configuration as that of the shield pulse signal generation section 85S. As a result, the backlight drive apparatus 45 includes the N shield pulse signal generation sections. Furthermore, the backlight drive apparatus 45 includes one shield pulse information generation section having a configuration similar to that of the transmission pulse information generation section 60 and connected to the N shield pulse signal generation sections.

The serial information S6 includes serial transmission pulse information, serial shield pulse information and peak value information. The serial shield pulse information includes N pieces of shield pulse information respectively corresponding to the N kinds of sink currents Jd. The timing control section 42 generates the serial shield pulse information so that the N pieces of shield pulse information represented by binary data are arranged sequentially with respect to time. Furthermore, the timing control section 42 generates the serial shield pulse information at each PWM cycle. The serial shield pulse information can change at each PWM cycle.

The shield pulse information generation section receives the serial shield pulse information inside the serial information S6 via the signal path P6 and receives the latch clock S9b via the signal path P9 from the timing control section 42 and then generates N kinds of shield pulse information in a way similar to that the transmission pulse information generation section 60 generates the N kinds of transmission pulse information S8. Each of the N shield pulse information generation sections generates the shield pulse signal on the basis of the shield pulse information in a way similar to that the shield pulse signal generation section 85S generates the shield pulse signal S85S on the basis of the shield pulse information S8b. As a result, the N shield pulse information generation sections generate the N kinds of shield pulse signals, respectively. The failure detection section receives the N kinds of shield pulse signals and compares the N kinds of detection voltages S14 with the predetermined voltage S23 in a period in which the N kinds of shield pulse signals are high level.

As described above, in the backlight drive apparatus 45 according to Modification example 1 of the first embodiment, since the backlight drive apparatus 45 is equipped with the N shield pulse signal generation sections, the timings of the N kinds of shield pulse signals can be adjusted optimally while respectively corresponding to the N kinds of transmission pulse signal S85T. Hence, the backlight drive apparatus 45 can further suppress the changes in the drive voltage S18 and the detection voltage S14 and can further stabilize the voltages.

### Modification Example 2 of the First Embodiment

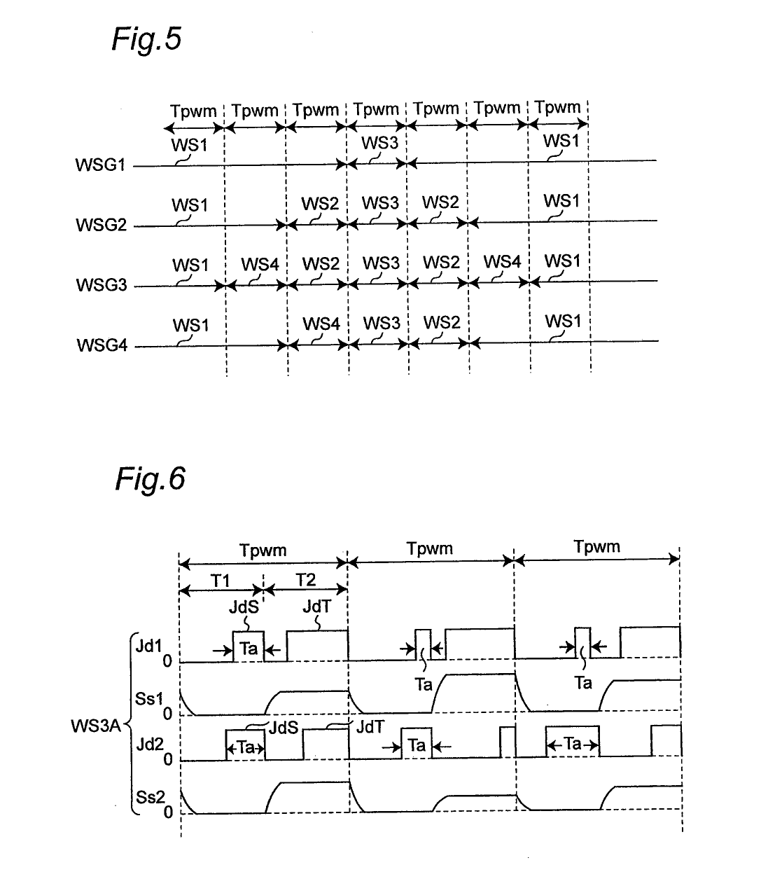

FIG. 5 shows waveform state groups representing the passage of time in the case that each waveform state is changed in units of PWM cycle Tpwm. In a waveform state group WSG1, the waveform state is usually the waveform state WS1, and the waveform state WS3 is inserted in one PWM cycle Tpwm at every plural PWM cycles Tpwm. In a waveform state group WSG2, the waveform state WS2 is inserted between the waveform state WS1 and the waveform state WS3 in the waveform state group WSG1. In the waveform state group WSG2, a slight change in brightness at the time of switching between the waveform state WS1 and the waveform state WS3 can be reduced to a negligible level by inserting the waveform state WS2.

A waveform state WS4 represents a state in which the peak values of the sink currents Jd1 and Jd2 in the waveform state WS2 are changed from the two times value to a 1.33 times value, for example, and the maximum on-duty ratios of the sink currents Jd1 and Jd2 in the waveform state WS2 are changed from 50% to 75%. In a waveform state group WSG3, the waveform state WS4 is inserted between the waveform state WS1 and the waveform state WS2 in the waveform state group WSG2. In the waveform state group WSG3, a slight change in brightness at the time of switching between the waveform state WS1 and the waveform state WS2 can be reduced to a negligible level by inserting the waveform state WS4. In a waveform state group WSG4, the waveform state WS2 in the waveform state group WSG3 is omitted. In the waveform state group WSG4, a slight change in brightness at the time of switching between the waveform state WS1 and the waveform state WS3 can be reduced to a negligible level by inserting the waveform state WS4.

The system control section 41 generates the system control signal S41 including the timing at which the waveform state WS3 is inserted. The timing control section 42 changes the transmission pulse information S8 and the shield pulse information S8b at each PWM cycle Tpwm on the basis of the system control signal S41. As described above referring to FIGS. 1A and 2, the transmission pulse information generation section 60 can make the N kinds of transmission pulse information S8 different from one another at each PWM cycle Tpwm and can change each of the N kinds of transmission pulse information S8 at each PWM cycle Tpwm. Similarly, the shield pulse information generation section 8b can change the shield pulse information S8b at each PWM cycle Tpwm. Furthermore, the timing control section 42 can change the liquid crystal video signal Ss at each PWM cycle Tpwm. As a result, the video display apparatus 70 shown in FIGS. 1A and 2 can attain the waveform state groups WSG1 to WSG4 shown in FIG. 5.

Moreover, the system control section 41 monitors only the state of the failure detection signal S22 at a PWM cycle Tpwm in which the waveform state WS3 is inserted and ignores the state of the failure detection signal S22 at other PWM cycles Tpwm. Hence, the video display apparatus 70 shown in FIGS. 1A and 2 can securely detect the failure state of only the waveform state WS3 in the waveform state groups WSG1 to WSG4 shown in FIG. 5. The failure state of the backlight panel 46 should only be able to be detected at a frequency of once in a second. Since this detection frequency is, for example, 100 times or more the PWM cycle Tpwm of 1/60 to 1/480 second, the waveform state WS3 should only be set at a frequency of once in 100 or more PWM cycles Tpwm. For this reason, image quality degradation, such as contrast reduction, for example, black floating caused by the light emission due to the shield pulse current JdS, can be suppressed to a minimum, and the increase in power consumption due to the addition of the shield pulse current JdS can be suppressed.

Instead of the method in which the system control section 41 ignores the state of the failure detection signal S22 as described above, a method may be used in which the failure detection section 22 forcibly sets the failure detection signal S22 to low level. Furthermore, the failure detection section 22 may switch the N kinds of inputs (the detection voltages S14) to a voltage lower than the predetermined voltage S23.

Furthermore, in the waveform state WS4 of the waveform state group WSCG4, it may be possible that a shield lighting period is provided in the remaining 25% period of the PWM cycle Tpwm as in the waveform state WS3 and that the sink current Jd is passed while the magnitude of the liquid crystal video signal Ss is set to low level. Moreover, although the maximum on-duty ratios and peak values are set to specific values in the above description, these values are given only as examples and may be different values. Still further, although the waveform state WS3 is inserted in units of PWM cycle Tpwm periodically, the operation of the failure detection section 22 in particular may start when the backlight drive apparatus 45 has shifted to its steady state after a predetermined period has passed from the operation start of the DC-DC converter 18, for example.

As described above, in the video display apparatus 70 according to Modification example 2 of the first embodiment, the timing control section 42 can attain the waveform state WS3 at a frequency of once at every plural PWM cycles Tpwm or during at least one specific period in the period of each PWM cycle Tpwm. Hence, in addition to the effects of the first embodiment, contrast reduction, for example, black floating caused by the light emission due to the shield pulse current JdS, can be suppressed. Furthermore, since the amount of the sink current Jd is reduced in the PWM cycles Tpwm in which the failure detection section 22 does not operate, the power consumption of the video display apparatus 70 can be lowered significantly.

### Modification Example 3 of the First Embodiment

FIG. 6 shows a waveform state WS3A serving as a modification example of the waveform state WS3 shown in FIG. 4. In the waveform state WS3, the shield lighting period Ta is set to a fixed on-duty ratio of 40% at all times, for example. However, in the waveform state WS3A, the shield lighting period Ta can be changed for each sink current Jd at each PWM cycle Tpwm.

The shield lighting period Ta, that is, the on-duty ratio of the shield pulse current JdS, is set at each PWM cycle Tpwm so as to compensate for the change in the on-duty ratio of the shield pulse current JdT. For example, the on-duty ratio of the shield pulse current JdS is set so that the sum of the on-duty ratio of the transmission pulse current JdT and the on-duty ratio of the shield pulse current JdS becomes a predetermined value and also becomes a predetermined minimum on-duty ratio or more at each PWM cycle Tpwm. Hence, the amount of the change in the total sink current J18 at each PWM cycle Tpwm can be set to a predetermined value or less or approximately zero amperes, and the change in the detection voltage S14 can be made sufficiently small. Furthermore, since the on-duty ratio of the shield pulse current JdS is the minimum on-duty ratio or more without exception, the failure detection section 22 can generate the failure detection signal S22 at all times.

The timing control signals S42a generated by the timing control section 42 include the serial information S6. The serial information S6 includes the serial shield pulse information instead of the shield pulse information. Like the transmission pulse information generation section 60, the shield pulse information generation section 8b includes N registers and one shift register.

The shift register receives, from the timing control section 42, the serial shield pulse information inside the serial information S6 via the signal path P6 and receives the shift clock S7 via the signal path P7. Furthermore, the shift register transfers the serial shield pulse information at the timing of N pulses of the shift clock S7 and generates N kinds of shield pulse information respectively corresponding to the N kinds of the sink currents Jd. The N registers receive the latch clock S9b from the timing control section 42 via the signal path P9 and latch (or store) the N kinds of shield pulse information at the timing of the latch clock S9b, thereby generating N kinds of shield pulse information S8. The N kinds of shield pulse information S8b can be made different from one another at each PWM cycle. Furthermore, the respective N kinds of transmission pulse information S8 can change at each PWM cycle Tpwm. In this way, the shield pulse information generation section 8b stores the serial shield pulse information sent from the timing control section 42 and generates the N kinds of shield pulse information S8b.

The total pulse signal generation section 10 latches the corresponding one of the N kinds of transmission pulse information S8 and the corresponding one of the N kinds of shield pulse information S8b at the timing of the duty master clock S11. Furthermore, the total pulse signal generation section 10 generates the total pulse signal S10 representing the logical OR of one transmission pulse signal S85T based on the latched transmission pulse information S8 and one shield pulse signal S85S based on the latched shield pulse information S8b at each PWM cycle Tpwm. The failure detection section 22 receives the N kinds of shield pulse signals S85S from the N total pulse signal generation sections 10, respectively, and generates a logical AND signal of the N kinds of shield pulse signals S85S. When at least one kind of detection voltage among the N kinds of detection voltages S14 becomes higher than the predetermined voltage S23 in a period in which the logical AND signal is high level, the failure detection section 22 generates the failure detection signal S22.

As described above, with the video display apparatus 70 according to Modification example 3 of the first embodiment, the timing control section 42 and the backlight drive apparatus 45 can set the on-duty ratio of the shield pulse current JdS at each PWM cycle Tpwm so as to compensate for the change in the on-duty ratio of the transmission pulse current JdT. Hence, in addition to the effects of the first embodiment, the amount of the change in the total sink current J18 at each PWM cycle Tpwm can be made sufficiently small, whereby the change in the detection voltage S14 can be suppressed further.

As described above, it is obvious that the video display apparatus 70 according to Modification example 3 of the first embodiment can be reconfigured in combination with the video display apparatus 70 according to Modification example 2 of the first embodiment, whereby the effects of both Modification examples 2 and 3 can be obtained.

### Second Embodiment

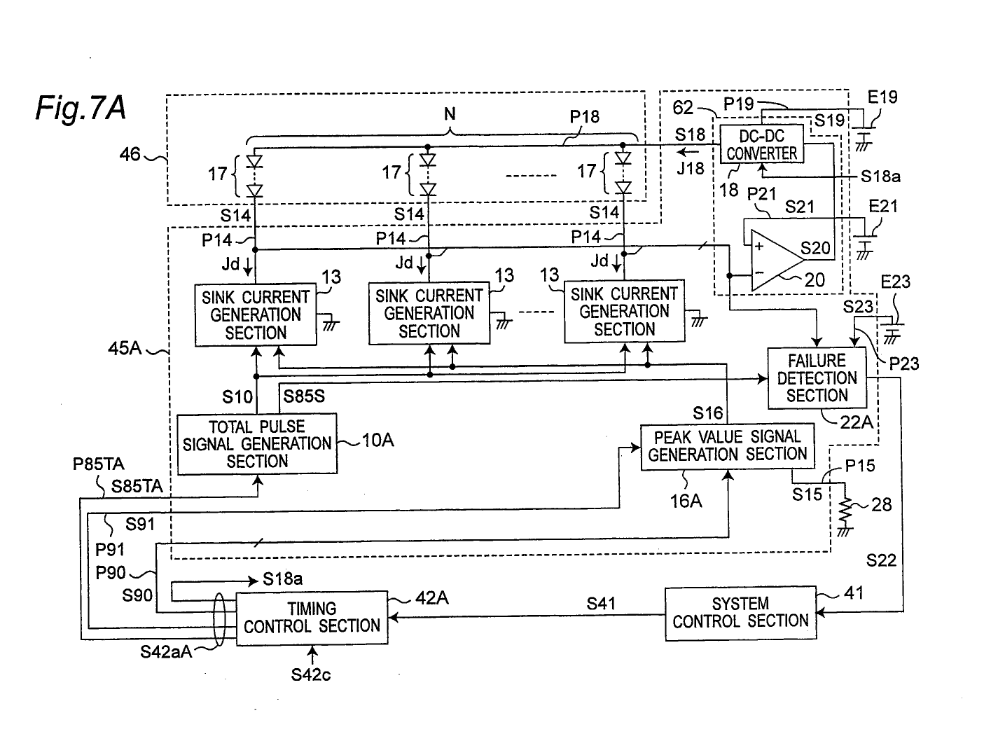

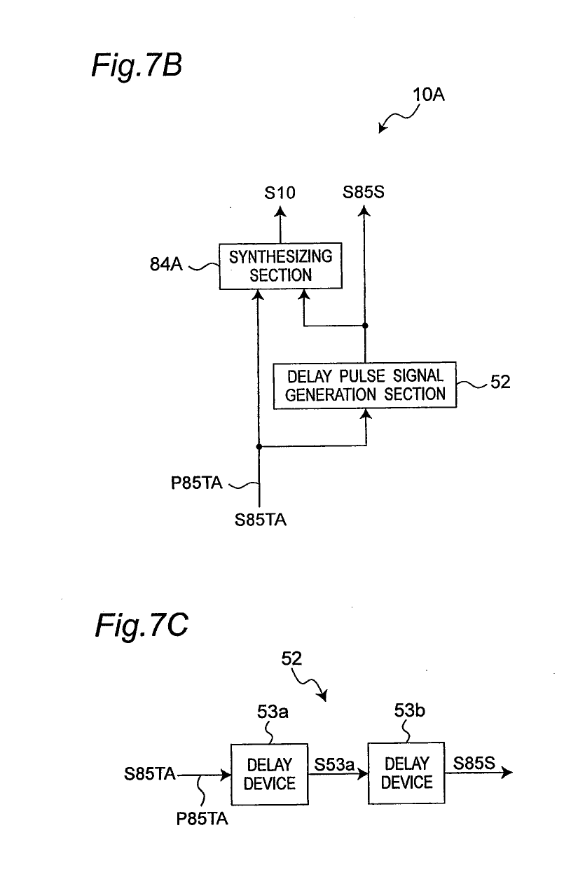

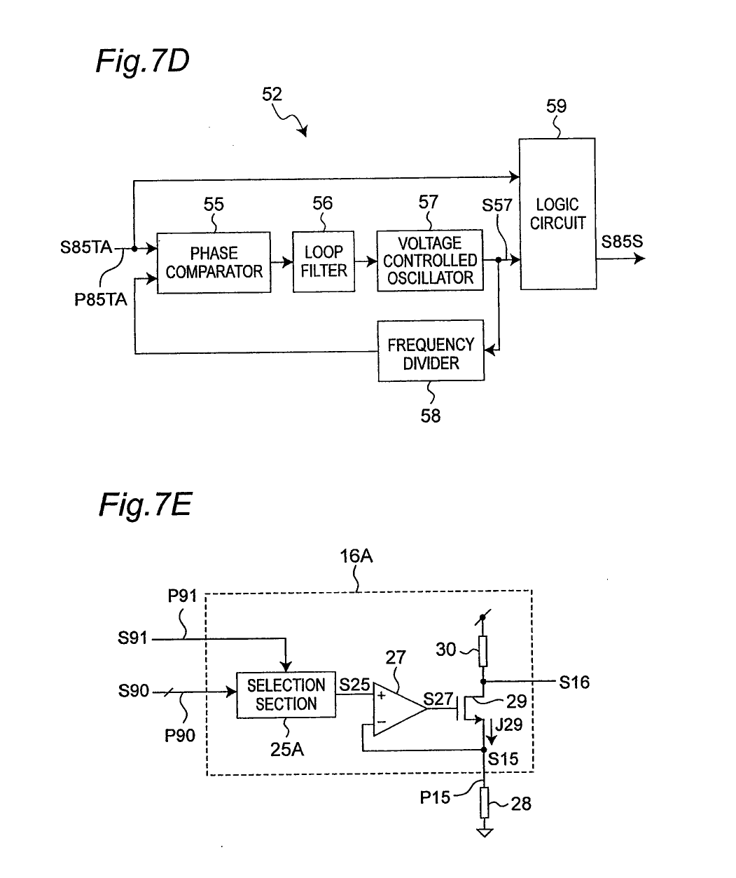

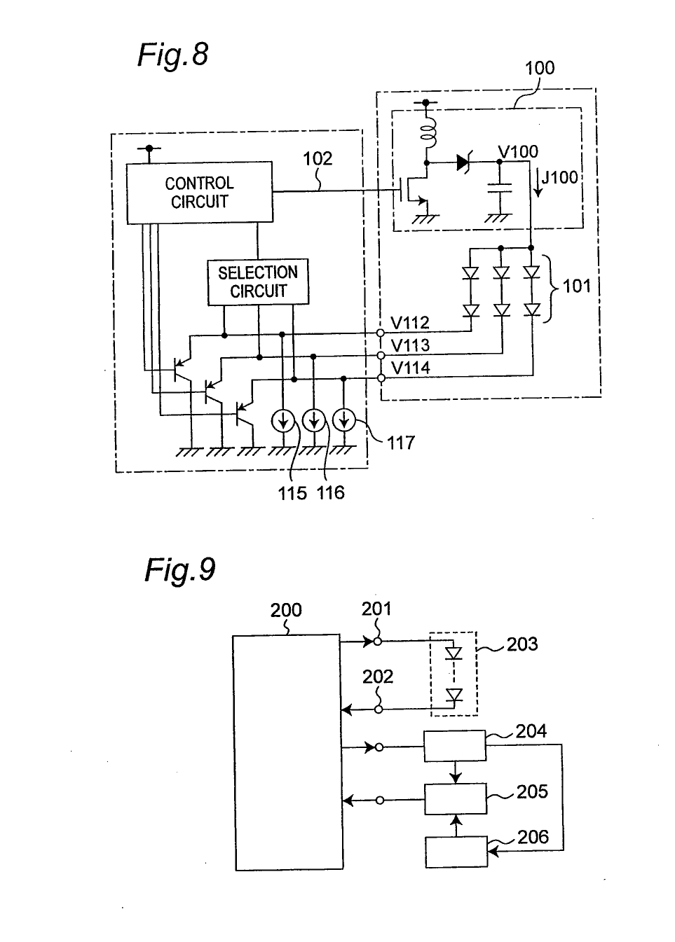

FIG. 7A is a block diagram showing a configuration example of a backlight drive apparatus 45A. The configuration shown in FIG. 7A is changed from the configuration shown in FIG. 1A in the following three points. First, the transmission pulse information generation section 60, the shield pulse information generation section 8b and the peak value information generation section 8a shown in FIG. 1A are omitted. Second, one total pulse signal generation section 10A is changed from the N total pulse signal generation sections 10, a peak value signal generation section 16A is changed from the peak value signal generation section 16, and a failure detection section 22A is changed from the failure detection section 22. As a result, a backlight drive apparatus 45A is changed from the backlight drive apparatus 45. Third, a timing control section 42A is changed from the timing control section 42. Since the other configurations, operations and effects according to the second embodiment are similar to those according to the first embodiment, their descriptions are omitted.

The backlight drive apparatus 45A includes the drive voltage generation section 62, the failure detection section 22A, the N (N is an integer of two or more) sink current generation sections 13, the one total pulse signal generation section 10A and the peak value signal generation section 16A. The configuration shown in FIG. 7A includes the backlight panel 46, the predetermined power source E19, the predetermined power source E21, the predetermined power source E23, the system control section 41 and the timing control section 42A, in addition to the backlight drive apparatus 45A.

The timing control section 42A generates plural kinds of timing control signals S42aA on the basis of the system control signal S41 and the video signal S42c. The timing control section 42A may be formed of a wired logic circuit or a microcomputer storing programs for generating the timing control signals S42aA. Furthermore, the timing control section 42A may also be formed of both the wired logic circuit and the microcomputer.

The timing control signals S42aA include a transmission pulse signal S85TA, multi-level peak value signals S90, a selection control signal S91 and the converter control clock S18a. The transmission pulse signal S85TA represents a signal equivalent to the transmission pulse signal S85T shown in FIGS. 1C and 3. In other words, the transmission pulse signal S85TA represents a pulse signal having an on-duty ratio based on the video signal S42c and generated at each PWM cycle Tpwm. The multi-level peak value signals S90 represent plural analog level signals generated in parallel. The selection control signal S91 represents a control signal for selecting either one of the plural analog level signals represented by the multi-level peak value signals S90.

The total pulse signal generation section 10A includes a delay pulse signal generation section 52 and a synthesizing section 84A as shown in FIG. 7B. The synthesizing section 84A has a function equivalent to that of the synthesizing section 84 shown in FIG. 1A. The total pulse signal generation section 10A receives the transmission pulse signal S85TA from the timing control section 42A via a signal path P85TA. The delay pulse signal generation section 52 delays the transmission pulse signal S85TA by a predetermined period and generates a shield pulse signal S85S. The shield pulse signal S85S represents a signal equivalent to the shield pulse signal S85S shown in FIGS. 1A, 1E and 3. The synthesizing section 84A synthesizes the transmission pulse signal S85TA and the shield pulse signal S85S and generates the total pulse signal S10. As described above, the total pulse signal generation section 10A generates the total pulse signal S10 including one transmission pulse signal S85TA and one shield pulse signal S85S at each PWM cycle Tpwm on the basis of the transmission pulse signal S85TA.

Next, a specific configuration example of the total pulse signal generation section 10A will be described below. An example of the delay pulse signal generation section 52 includes a delay device 53a and a delay device 53b as shown in FIG. 7C. The delay devices 53a and 53b are single-shot multivibrators respectively having predetermined delay times, for example. The delay devices 53a and 53b may be formed of a counter.

In the case that the transmission pulse signal S85TA corresponds to the transmission pulse signal S85T in the timing state TS1 shown in FIG. 3, the delay device 53a generates a delay signal S53a that rises after the predetermined period 32 has passed from the rising time of the transmission pulse signal S85TA. Then, the delay device 53b generates the shield pulse signal S85S that becomes high level during the predetermined period 33 from the rising time of the delay signal S53a. The synthesizing section 84A generates the total pulse signal S10 representing the logical OR of the transmission pulse signal S85TA and the shield pulse signal S85S.

In the case that the transmission pulse signal S85TA corresponds to the transmission pulse signal S85T in the timing state TS2, the delay device 53a generates the delay signal S53a that rises after the predetermined period 32 has passed from the lowering time of the transmission pulse signal S85TA. Then, the delay device 53b generates the shield pulse signal S85S that becomes high level during the predetermined period 33 from the rising time of the delay signal S53a. The synthesizing section 84A generates the total pulse signal S10 representing the logical OR of the transmission pulse signal S85TA and the shield pulse signal S85S.

In another configuration example of the total pulse signal generation section 10A, the delay pulse signal generation section 52 includes a phase comparator 55, a loop filter 56, a voltage controlled oscillator 57, a frequency divider 58 and a logic circuit 59. The phase comparator 55, the loop filter 56, the voltage controlled oscillator 57 and the frequency divider 58 constitute a PLL (phase-locked loop) circuit. In synchronization with the phase of the transmission pulse signal S85TA, the PLL circuit generates an integer multiple pulse signal S57 having a frequency (a cycle equal to an integer fraction of the PWM cycle Tpwm) that is an integer multiple of the frequency of the transmission pulse signal S85TA, The logic circuit 59 generates the shield pulse signal S85S on the basis of the transmission pulse signal S85TA and the integer multiple pulse signal S57.

In the case that the transmission pulse signal S85TA corresponds to the transmission pulse signal S85T in the timing state TS1 shown in FIG. 3, the logic circuit 59 shuts off the flow of the integer multiple pulse signal S57 during a predetermined period from the rising time of the transmission pulse signal S85TA. Then, the logic circuit 59 allows the integer multiple pulse signal S57 to flow until the rising time of the next transmission pulse signal S85TA, thereby generating the shield pulse signal S85S. In the case that the transmission pulse signal S85TA corresponds to the transmission pulse signal S85T in the timing state TS2, the logic circuit 59 allows the integer multiple pulse signal S57 to flow during a predetermined period from the lowering time of the transmission pulse signal S85TA, thereby generating the shield pulse signal S85S. After the predetermined period, the logic circuit 59 shuts off the flow of the integer multiple pulse signal S57 until the lowering time of the next transmission pulse signal S85TA. In both the timing states TS1 and TS2, the predetermined period is set to approximately half the PWM cycle Tpwm, for example.

As shown in FIG. 7E, the peak value signal generation section 16A includes a selection section 25A, the operational amplifier 27, the transistor 29 and the resistor 30. The drain of the transistor 29 is connected to a power source via the resistor 30, the source thereof is grounded via the signal path P15 and the resistor 28, and the gate thereof is connected to the output terminal of the operational amplifier 27. The selection section 25A receives the multi-level peak value signal S90 via the signal path P90 and receives the selection control signal S91 via the signal path P91 from the timing control section 42A. The selection section 25A selects one of the plural analog level signals represented by the multi-level peak value signals S90 on the basis of the selection control signal S91 and generates the analog level S25 representing the selected level. The operations of the operational amplifier 27 and the transistor 29 are as described above referring to FIG. 1B. As described above, the peak value signal generation section 16A generates the peak value signal S16 representing the peak value of the sink currents Jd on the basis of the multi-level peak value signals S90 and the selection control signal S91.

Each of the N sink current generation sections 13 adjusts the sink current Jd as described above referring to FIG. 1A on the basis of the peak value signal S16 and one kind of total pulse signal S10.

The failure detection section 22A receives the predetermined voltage S23 from the power source path P23 and receives the N kinds of detection voltages S14. The failure detection section 22A receives one kind of shield pulse signals S85S from the one total pulse signal generation section 10A. The other operations of the failure detection section 22A are similar to those of the above-mentioned failure detection section 22 described above referring to FIG. 1A.

As described above, with the backlight drive apparatus 45A and the video display apparatus according to the second embodiment, in the case of adjusting the N kinds of sink currents Jd depending on the video signal S42c similarly, the N sink current generation sections 13 should only make the adjustment on the basis of the total pulse signal S10 generated by the one total pulse signal generation section 10A. Hence, the required number of the total pulse signal generation sections 10A can be reduced to 1 from N; N is the number of the total pulse signal generation sections 10. Furthermore, since the total pulse signal generation section 10A generates the shield pulse signal S85S from the transmission pulse signal S85TA, the circuit size thereof can be reduced in comparison with the total pulse signal generation section 10. By virtue of these reductions in the circuit sizes, the cost of the video display apparatus according to the second embodiment can be reduced in comparison with the video display apparatus according to the first embodiment.

### Summary of Embodiments

As described above, with the backlight drive apparatus and the video display apparatus according to the preferred embodiment of the present invention, the total pulse signal generation section (10; 10A) generates the total pulse signal S10 including one transmission pulse signal (S85T; S85TA) and one shield pulse signal S85S at each PWM cycle Tpwm. Furthermore, the sink current generation section 13 can adjust the sink current Jd to the transmission pulse current JdT corresponding to the transmission pulse signal (S85T; S85TA) and to the shield pulse current JdS corresponding to the shield pulse signal S85S. Hence, the backlight drive apparatus balances the sink currents Jd respectively flowing through the N strings 17 with respect to time to lower the dependency on the video signal S42C, thereby being capable of reducing the change in the total sink current J18. As a result, the backlight drive apparatus can suppress the change in the drive voltage S18 and the detection voltage S14 and can stabilize the voltages. In addition, the timing control section (42; 42A) forcibly sets the liquid crystal video signal Ss to zero level at the generation time of the shield pulse current JdS, thereby being capable of preventing the light emission of the backlight panel 46 due to the shield pulse current JdS from affecting the brightness of the video display apparatus. Furthermore, the failure detection section (22; 22A) can monitor the stabilized detection voltage S14 at the generation time of the shield pulse signal S85S by performing comparison in the high level period of the shield pulse signal S85S, thereby being capable of securely detecting the failure state of the backlight panel 46.

Furthermore, with the video display apparatus according to the preferred embodiment of the present invention, the timing control section 42 can attain the waveform state WS3 at a frequency of once at every plural PWM cycles Tpwm or during at least one specific period in the period of every PWM cycle Tpwm. Hence, contrast reduction, for example, black floating caused by the light emission due to the shield pulse current JdS, can be suppressed. Furthermore, since the amount of the sink currents Jd is reduced in the PWM cycles Tpwm in which the failure detection section 22 does not operate, the power consumption of the video display apparatus can be lowered significantly.

Moreover, with the video display apparatus according to the preferred embodiment of the present invention, the timing control section 42 and the backlight drive apparatus can set the on-duty ratio of the shield pulse current JdS at each PWM cycle Tpwm so as to compensate for the change in the on-duty ratio of the transmission pulse current JdT. Hence, the amount of change in the total sink current J18 at each PWM cycle Tpwm can be made not more than the predetermined value, whereby the change in the detection voltage S14 can be suppressed further.

Furthermore, with the backlight drive apparatus and the video display apparatus according to the preferred embodiment of the present invention, in the case of adjusting the N kinds of sink currents Jd depending on the video signal S42c similarly, the N sink current generation sections 13 should only make the adjustment on the basis of the total pulse signal S10 generated by the one total pulse signal generation section 10A. Hence, the required number of the total pulse signal generation sections 10A can be reduced to 1 from N; N is the number of the total pulse signal generation sections 10. Furthermore, since the total pulse signal generation section 10A generates the shield pulse signal S85S from the transmission pulse signal S85TA, the circuit size thereof can be reduced in comparison with the total pulse signal generation section 10. Still further, since the peak value signal generation section 16A uses the selection section 25A instead of the DA converter 25 of the peak value signal generation section 16, the circuit size thereof can be reduced. By virtue of these reductions in the circuit sizes, the cost of the video display apparatus according to the preferred embodiment of the present invention can be reduced.

In the above descriptions, the numerals described above are used as examples to specifically explain the present invention, and the present invention is not limited by the numerals used as examples. Furthermore, the logic levels represented by high level/low level are used as examples to specifically explain the present invention. In the case that the configuration of the logic circuit is changed, a similar result can be obtained by combining logic levels different from the logic levels used as examples. Moreover, the components configured by hardware can be configured by software, and the components configured by software can also be configured by hardware. Still further, in the case that some of all the components of the above-mentioned embodiments are reconfigured so as to be combined in a manner different from the combinations according to the above-mentioned embodiments, the effects of the different combination can be attained.

The aforementioned descriptions of the embodiments are all examples specifically explaining the present invention. The present invention is not limited to these examples, but may be modified into various examples that can be configured easily by those skilled in the art by using the technology according to the present invention.

The disclosure of Japanese Patent Application No. 2009-233017 filed Oct. 7, 2009 including the specification, the drawings and the claims is incorporated herein by reference in its entirety.

1. A backlight drive apparatus for current driving a plurality of strings, having a period in which at least one of said strings is current driven idly during a liquid crystal OFF period, in addition to a current driving period in which video information is displayed via liquid crystals.

2. The backlight drive apparatus according to claim 1, wherein a load connection test is carried out for the string during the period in which the string is current driven during said liquid crystal OFF period.

3. The backlight drive apparatus according to claim 2, wherein said load connection test for the string is carried out for all the strings concurrently.

4. The backlight drive apparatus according to claim 2, wherein the detection of the potential at a load connection point includes making a judgment as to whether the potential at the connection point of the load string having the smallest potential drop and a current driving section is less than a predetermined value.

5. The backlight drive apparatus according to claim 4, comprising a timer for making a judgment as to whether the period in which the potential at said connection point is less than the predetermined value has continued for a predetermined time or more.

6. The backlight drive apparatus according to claim 4, wherein the judgment as to whether the potential at said connection point is less than the predetermined value is made for at least the current-driven string.

7. The backlight drive apparatus according to claim 4, wherein, during a period in which the potential at said load connection point is not detected, a judgment is made while the potential is used, instead of the potential at each connection point, as a predetermined value not contributing to abnormality judgment.

8. The backlight drive apparatus according to claim 1, wherein said backlight drive apparatus includes a power source control function for a common feeding point from which power is fed to the backlight loads of said plurality of strings.

9. The backlight drive apparatus according to claim 1, wherein the period in which the string is current driven during said liquid crystal OFF period is provided during a blanking period in an operation mode for improving the characteristics of moving images.

10. The backlight drive apparatus according to claim 1, wherein the transmittance of liquid crystals is lowered during a period in which current drive for displaying video information via liquid crystals for all the strings is not carried out and, at the same time, a load current is applied to at least one string to perform idling.

11. A backlight drive apparatus comprising a plurality of sink current generation sections to each of which a load is connected and total pulse signal generation sections for controlling said sink current generation sections, further comprising a shield pulse signal generation section for turning ON said sink current generation sections during said liquid crystal OFF period and a failure detection section for detecting an abnormal change in the voltage at said load connection point.

12. The backlight drive apparatus according to claim 11, wherein the voltage at said load connection point of the load string having the smallest voltage drop and said sink current generation section is input to said failure detection section for judging that the voltage at said load connection point is higher than the predetermined value.

13. The backlight drive apparatus according to claim 12, wherein the potentials at the connection points of the strings not current-driven or the potentials at the connection points of the respective strings during a period in which the potentials at the connection points are not judged are not input to said failure detection section, but a predetermined value is input instead.

14. The backlight drive apparatus according to claim 11, further comprising a feeding circuit for a common connection point from which power is fed to the backlight loads of said plurality of strings, wherein said feeding circuit controls so a s to maintain the potential at said load connection point at a predetermined level.

15. A video display apparatus incorporating the backlight drive apparatus according to claim 11.

16. A backlight drive apparatus for driving at least one string including one or more light-emitting devices, comprising:
a drive voltage generation section for generating a drive voltage and for supplying the drive voltage to said string via a first path,
sink current generation sections for generating sink currents and for supplying said sink currents to said strings via second detection paths disposed on the opposite side of said first path with said strings interposed therebetween,
total pulse signal generation sections each for generating a first pulse signal having an on-duty ratio based on an input video signal and a second pulse signal complementing said first pulse signal during at least one specific period in the period of every predetermined cycle, wherein
said drive voltage generation section adjusts said drive voltage on the basis of a detection voltage on said second path, and
said sink current generation sections each adjust said sink current on the basis of said first pulse signal and said second pulse signal.

17. The backlight drive apparatus according to claim 16, further comprising a failure detection section for comparing said detection voltage with a predetermined voltage.

18. A video display apparatus comprising:
the backlight drive apparatus according to claim 16,
a timing control section for generating a reference video signal representing a level serving as the reference of said video signal corresponding to the region illuminated by said string and for generating a liquid crystal video signal obtained by normalizing said video signal using said reference video signal, and
a liquid crystal drive section for driving a liquid crystal panel on the basis of said liquid crystal video signal, wherein
said total pulse signal generation sections each adjust the on-duty ratio of said first pulse signal on the basis of said reference video signal, and
said timing control section sets, in said specific period, said liquid crystal video signal to approximately zero level while said second pulse signal is generated.

19. A video display apparatus incorporating the backlight drive apparatus according to claim 12.

20. A video display apparatus incorporating the backlight drive apparatus according to claim 13.

21. A video display apparatus incorporating the backlight drive apparatus according to claim 14.
